(19) United States
(12) Patent Application Publication
(10) Pub. No.: US 2011/0102133 A1
(43) Pub. Date: May 5, 2011

(54) PROGRAMMABLE SECURITY SYSTEM WITH TRANSMITTER

(75) Inventor: Thomas Shaffer, Pleasant Grove, UT (US)

(73) Assignee: Thomas G. Shaffer, Pleasant Grove, UT (US)

(21) Appl. No.: 12/611,196

(22) Filed: Nov. 3, 2009

(51) Int. Cl. G06F 7/04; G08B 3/00

(52) U.S. Cl. 340/5.1; 340/384.1

(57) ABSTRACT

A security system comprising an audible alarm with a microphone within acoustic range of the audible alarm. A storage circuit configured to store at least one acoustic fingerprint. A processing circuit coupled to the storage circuit and configured to create a first acoustic fingerprint from a first signal from the microphone and save the first acoustic fingerprint on the storage circuit. The processing circuit further configured to create a second acoustic fingerprint from a second signal from the microphone and compare the first acoustic fingerprint to the second acoustic fingerprint. The processing circuit further configured to transmit a set of data if the first acoustic fingerprint matches the second acoustic fingerprint. A transmitter coupled to the processing circuit and configured to transmit the set of data. The security system has the advantage to be installed without using wire connections to existing alarm systems or decode their radio frequencies.

### BACKGROUND OF THE INVENTION

In current security systems a central processing unit receives a signal from a detection device such as a smoke detector, motion sensor, carbon monoxide sensor etc. These signals are carried from the detection devices to the central processing unit through a wiring system. For this reason, installing a new security system in an existing home requires running wiring from the detection devices to the central process unit. This process requires extensive demolition and repair to existing walls. This demolition and installation is expensive and running the wires on the outside of the walls to reduce cost is not aesthetically acceptable.

Many of the existing security systems are installed as part of monitoring agreement where a security company sells the central processing unit and provides monitoring services for a monthly fee. Changing to a different monitoring company requires changing the central processing unit to meet the new monitoring company's requirements. This involves having to attach the correct wires to the correct terminals on the new central processing unit. This process can be expensive and limits an owner's ability to change security monitoring companies because a professional installer is required to install the system.

Many existing systems carry a signal from the detection device to the central processing unit through a radio signal. When a user wants to switch to a new service provider a new panel has to be installed that is compatible with the radio signals of the detection devices. This includes replacement of the receiving devices and the central processing unit. In many cases the complete system has to be replaced including the detection devices. In each case this is a costly replacement that requires a professional service technician to make the replacement.

What is needed is a central process unit that can replace an existing security system without having to connect to the existing wiring system. Additionally, what is needed is a central process unit that can be installed in an existing home without having to run new wiring and is simple to program. Further, what is needed is a central processing unit that can be used for any type of security system and replace the existing security provider without having to replace significant amounts of the system.

### SUMMARY OF THE INVENTION

Embodiments of a method are described. In one embodiment, the method is a method for programming a security system. The method comprises activating an audible alarm and creating an electronic signal of the audible alarm. The electronic signal is then processed to create an acoustic fingerprint. This acoustic fingerprint is stored in a readable format. Other embodiments of the method are also described.

Embodiments of a method are also described. In one embodiment, the method is a method for signaling. The method comprises activating an audible alarm and matching the acoustic fingerprint of the audible alarm to a previously stored acoustic fingerprint. Once the fingerprint has been matched, a first signal with a first set of data is transmitted to a central processing unit. The data from the first signal is then matched to a second set of data and the central processing unit transmits a second signal with the second set of data. Other embodiments of the method are also described.

Embodiments of an apparatus are also described. In one embodiment, the apparatus is a security system. The security system comprising an audible alarm with a microphone within acoustic range of the audible alarm. A storage circuit configured to store at least one acoustic fingerprint. A processing circuit coupled to the storage circuit and configured to create a first acoustic fingerprint from a first signal from the microphone and save the first acoustic fingerprint on the storage circuit. The processing circuit further configured to create a second acoustic fingerprint from a second signal from the microphone and compare the first acoustic fingerprint to the second acoustic fingerprint. The processing circuit further configured to transmit a set of data if the first acoustic fingerprint matches the second acoustic fingerprint. A transmitter coupled to the processing circuit and configured to transmit the set of data. Other embodiments of the apparatus are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a panel of a security system program box.

FIG. 2 depicts a schematic diagram of a circuit.

FIG. 3 depicts a schematic diagram of a security system.

FIG. 4 depicts a schematic diagram of one embodiment of a method for signaling.

FIG. 5 depicts a schematic diagram of one embodiment of a method for programming a security system.

FIG. 6 depicts an embodiment of a panel of a security system program box.

Throughout the description, similar reference numbers may be used to identify similar elements.

### DETAILED DESCRIPTION

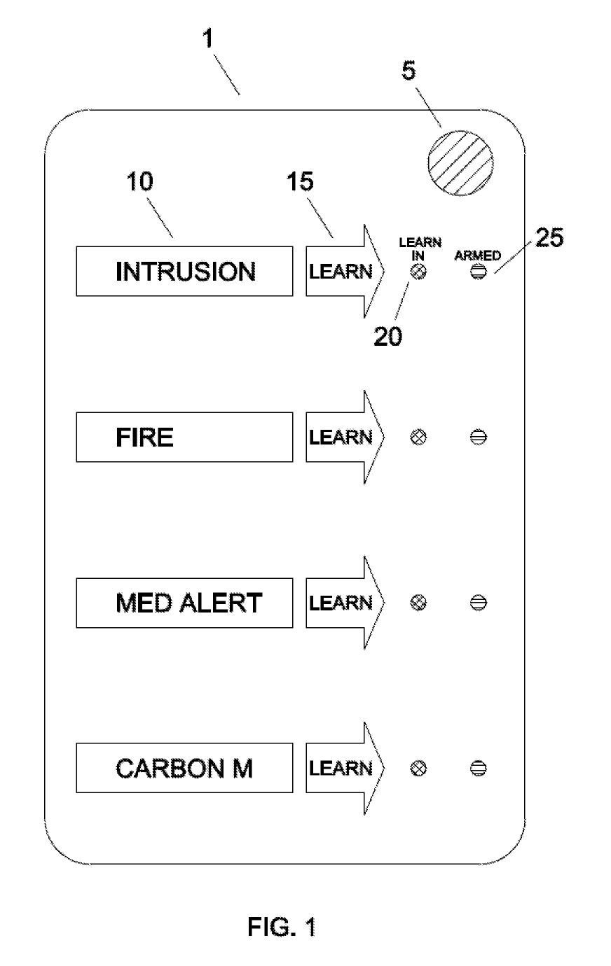

FIG. 1 depicts a panel 1 of a security system program box. Microphone slot 5 allows sound to pass through the panel 1. Label 10 indicates the type of alarm to be recognized. Learn button 15 is used to start the recording process for a particular alarm. Learn light 20 indicates when an alarm is being learned, label 10 indicates when an alarm has been learned, and armed light 25 indicates when the corresponding alarm is armed.

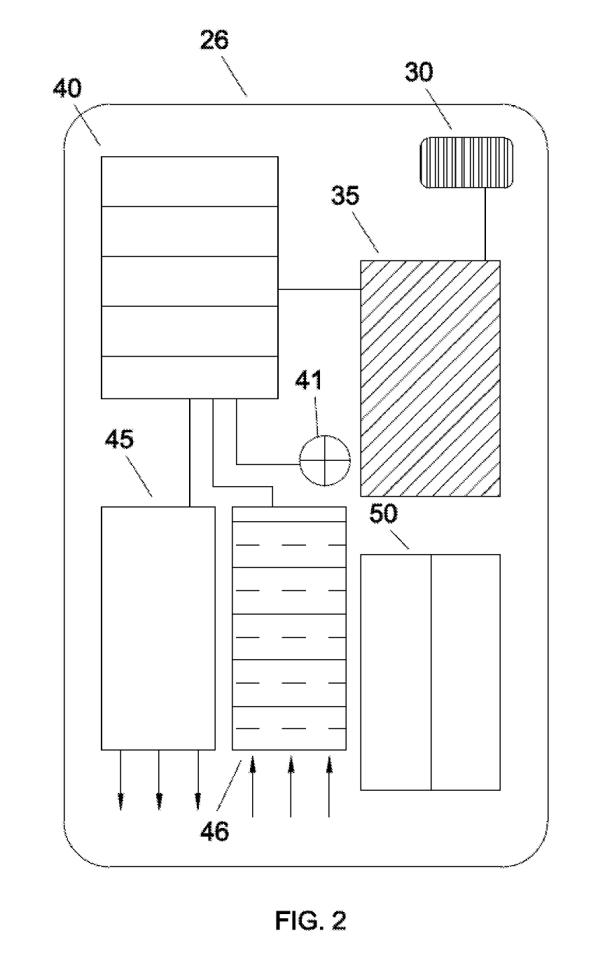

In one embodiment the panel is used by pressing the learn button 15 and learn light 20 turns on. The user the goes to an audible alarm and waits for fifteen seconds for a beep. After the beep, the user activates the audible alarm. The sound from the audible alarm passes through the microphone slot 5 to microphone 30 (FIG. 2). Once the alarm sound has been recorded and recognized the learn light 15 turns off. Armed light 25 is on while the alarm is armed. The audible alarm to be programmed in can be activated by pressing the test button or by tripping a sensor when the alarm is on. This can be done on any type of audible alarm within audible range of the microphone 30 (FIG. 2)

In one embodiment panel 1 can be made of plastic or any other suitable material. Label 10 can be mast of plastic or any other suitable material and learn button 15 can be made of plastic or any other suitable material. Learn light 20 and armed light 25 can be LED lights or any other suitable light.

In FIG. 1 label 10 lists some of the possible alarm types including intrusion alarm, fire alarm, medical alert, alarm and carbon monoxide alarm. This list is not intended to limit the types of alarms that could be used with the security system. Any type of alarm or notification device can be used as long as there is an audible notification. Examples of the types of audible alarms or notification devices are intruder alarms, smoke detectors, heat detectors, medical pendant detectors, carbon monoxide detectors, tornado sirens, nuclear power plant sirens, flood alarms and any other device that emits an audible sound.

FIG. 2 depicts a schematic diagram of a circuit board 26. Microphone 30 converts sound to an electronic signal and is electronically connected to central processing unit (CPU) 40. CPU 40 is electronically attached to storage device 35, speaker 41, transmitter 45, and receiver 46. Battery 50 is connected to power the entire circuit. Additionally, the unit can be powered by an outside power source.

In one embodiment the circuit 26 operates in two different ways. First, when the learn button 15 is pressed, microphone 30 converts a sound into an electronic signal that is converted to a first acoustic fingerprint by CPU 40. An acoustic fingerprint is a digital representation of the sound based on time, frequency, and intensity and is well know means for distinguishing different sound types. The first acoustic fingerprint is then stored on storage device 35. In one embodiment the armed light 25 will light when at least one acoustic fingerprint has been stored. The second way the circuit 26 is designed operate is when the device is armed, sound transmitted to microphone 30 is converted to a second acoustic fingerprint by CPU 40 and compared with the first acoustic fingerprint stored on the storage device 35. If the first acoustic fingerprint matches the second acoustic fingerprint, the CPU 40 transmits a command to the transmitter 45 to transmit a signal with data from the storage device 35 that corresponds with the first acoustic fingerprint. Transmitter 45 can either transmit wirelessly, through a phone line, through the internet, or any other suitable means of transmitting data. In one embodiment Transmitter 45 is programmed to transmit data wirelessly, through a phone line, and through the internet. In one embodiment this data is sent in the form of a text message through a cellular service provider. In another embodiment this information is sent through an existing phone connection.

In one embodiment learn button 15 can be used to store multiple sounds for a single alarm type. For example, if multiple smoke detectors are used in a home each with a different audible notification, each audible notification acoustic fingerprint can be stored in the storage device 35 and all acoustic fingerprints stored will correspond to the fire alarm. This is accomplished by pressing the learn button a second time for a second audible sound. Once the maximum number of sounds have been recorded, the learn light 20 will not longer turn on. The acoustic fingerprints corresponding to a particular alarm can be deleted by holding down the learn button 15 until the device beeps. When the acoustic fingerprint associated with a particular alarm has been erased the armed light 25 will turn off.

In one embodiment the circuit 26 has a learning mode method of programming. When the circuit 26 is in learning mode the microphone 30 will detect sounds or frequencies above a certain range for a certain period of time. For example, during the learning mode, microphone 30 would be activated for a period of 15 seconds. During that time, all sounds would be monitored by microphone 30 and CPU 40. Any sound above 65 decibels would be would be converted into an acoustic fingerprint and stored on storage device 35. Because smoke alarms produce a sound louder than sixty-five decibels at fifty feet, the smoke detectors would be stored.

In one embodiment CPU 40 will only process sounds with an amplitude or frequency above a specified threshold. This threshold can also be determined by a combination of the characteristics acoustic fingerprint of each sound. This means that CPU 40 will only operate when a sound that is as loud as an alarm is detected by microphone 30. This will conserve power usage and save processing power.

In one embodiment of the invention, the data stored on the storage device 35 corresponds to a particular acoustic fingerprint. For example, the acoustic fingerprint corresponding to the sound emitted by a smoke detector would relate to data that would indicate that a smoke alarm had been activated. Additionally, data could be stored that corresponded to an intrusion alarm, carbon monoxide alarm, etc. In each case different data would match and be sent to transmitter 45 for each different acoustic fingerprint. Additionally, the data would include information to identify the location of the circuit 26.

All the items described on circuit 26 are well known and many different options are available to create a working circuit board. In one embodiment microphone 30, CPU 40, speaker 41, storage device 35, transmitter 45, receiver 46, and battery 50 is the same as found in a Motorola i265. The Motorola i265 is compatible with java. The audio to acoustic fingerprint conversion and recognition software and all other required operational programs needed for the described embodiments can be programmed into the Motorola i265 CPU using Java. In one embodiment the software used for the audio conversion is Luscina or Analyser. Additionally, the Motorola i265 has a two way radio feature that could allow for direct communication through circuit 26. This will allow a monitoring station to audibly verify all is well or if there is a problem. The system can be tested to see if it is online by sending text message to circuit 26 that circuit 26 will automatically reply to.

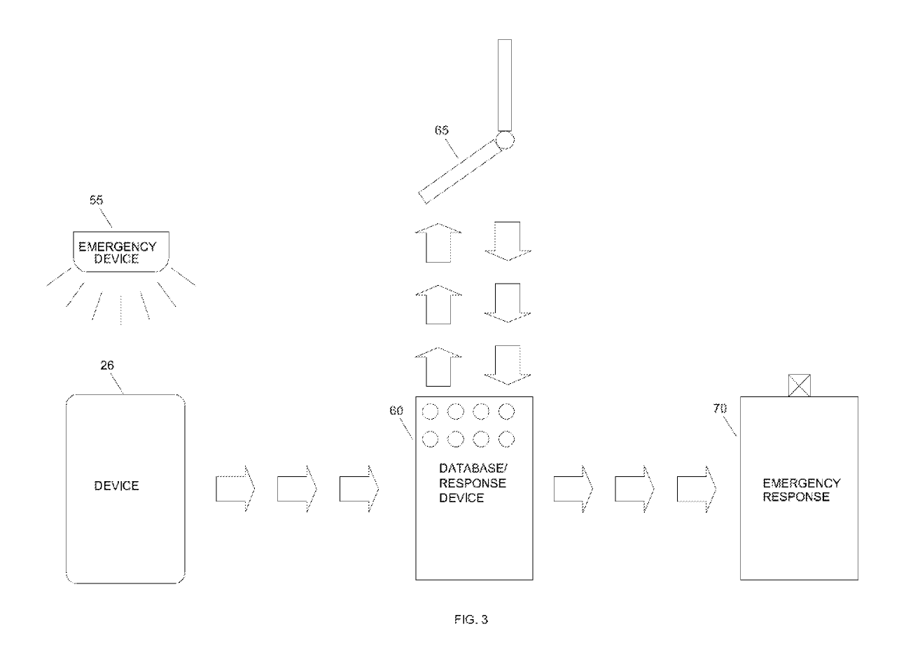

FIG. 3 depicts a schematic diagram of security system. Emergency device 55 emits an audible sound within range of circuit 26. Circuit 26 creates an acoustic fingerprint of the sound and compares it with the fingerprints already stored. If the fingerprint matches a stored fingerprint, circuit 26 transmits a signal containing the alarm type and location of the alarm to a database response device 60. The database response device 60 then retrieves information corresponding to the transferred data. In one embodiment this data includes, alarm type, owner's name, owners address, emergency contact information, contact telephone number, information on whether emergency personnel should be contacted and when and how they should respond.

In one embodiment the database response device 60 then sends a signal to the phone 65. In one embodiment the database response device 60 use's a text to speech software conversion or a prerecorded message to generate a customized message. For example, the message will say “your smoke detectors are going off. Press ‘0’ or enter and incorrect 4 digit code now to have us dispatch services immediately. Otherwise enter your correct 4 digit code now.” The message could be customized to match any alarm type. If a client does not answer the phone, the database response device 60 will be programmed to follow a predefined protocol for each alarm type. This may include, calling a second number, sending emergency services, calling an operator, etc. If emergency services are required, the database response device 60 will then contact emergency services with the type of alarm and location of circuit 26 and other information as needed. All of this information will be stored on the database response device 60.

In one embodiment database response device 60 will immediately dispatch emergency services for a medical alert alarm. A phone call will still be made to the client, but emergency services will be dispatched first. This is because a medical alert alarm is usually purposely activated by the client.

In one embodiment monitoring database 60 will send a confirmation massage to circuit 26. If circuit 26 does not receive the message within a specified period of time, circuit 26 will send a second message to monitoring database 60. This will assure that monitoring database 60 received the first message.

Emergency services can be a fire department, police station, private security company, chemical cleanup, private security contractor or any other type of emergency response service.

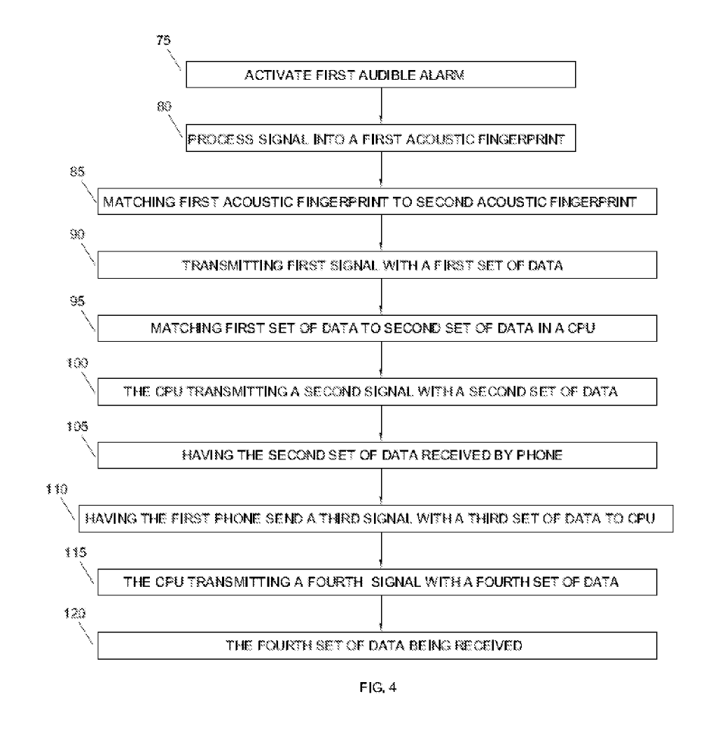

FIG. 4 depicts a schematic diagram of one embodiment of a method for signaling. In one embodiment the method is as follows. An audible alarm is activated 75. The sound from the audible alarm is processed into a first acoustic fingerprint 80 and matched to a second acoustic fingerprint 85. A first signal is transmitted with a first set of data 90 and received in a data base response device 60 with a CPU. The CPU matches the first set of data to a second set of data 95 stored in the database response device 60. The CPU then transmits a second set of data 100 on a second signal to a phone 105 and the phone transmits a third set of data entered by a user back to the CPU 110 located in data base response device 60. The CPU then transmits a fourth set of data stored on the CPU on a fourth signal 115. The data is received 120 by an emergency response services. This data can be sent though a land line, two way radio, cellular service provider or other suitable means.

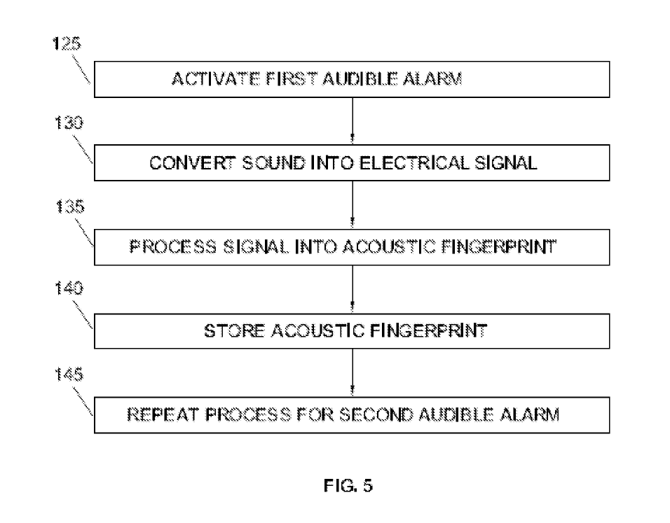

FIG. 5 depicts a schematic diagram of one embodiment of method for programming a security system. In one embodiment the method is as follows. An audible alarm is activated 125. The sound from the audible alarm is processed into an electrical signal 130 and then processed into and acoustic fingerprint 135 which is stored 140. This process can then be repeated 145 for a second audible alarm.

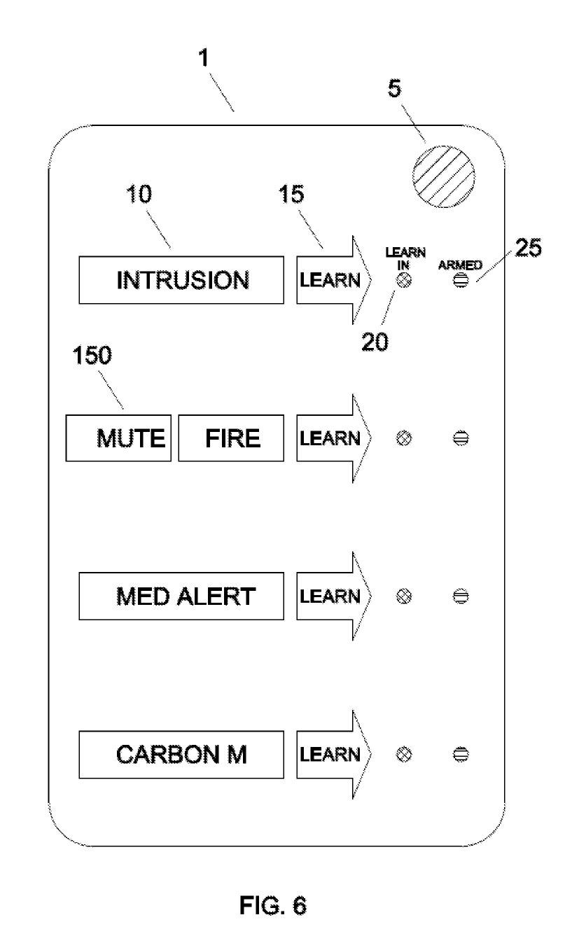

FIG. 6 depicts an embodiment of a panel of a security system program box. Mute button 150 is located on panel 1 and coupled to CPU 40 (FIG. 2). In one embodiment the mute button 150 is used in the following manner. If mute button 150 is pressed and a smoke detection device is activated, CPU 40 will wait a first period of time and recheck to see if the smoke detection device is still active. If the device is still active, CPU will proceed with sending a message to transmitter 45 (FIG. 2). If the mute button 150 is pressed during the first period of time, CPU will wait an additional period of time before rechecking to determine of the smoke alarm is still active. These periods of time will allow a user time to clear the house of smoke in case of burned food or other non-threatening fire. In addition, activating the mute button will allow response device 60 to directly call the fire department without having to call the home first because it reduces the chance of a false alarm. This will save time in the event of a fire that will damage property or people.

This security system presents many advantages over current security systems. Some of the advantages are: no phone line is required for installation, the system can be used with any existing security system without time and cost consuming installation, no wiring is required so the system can be installed into any house, the system can be customized to recognize any audible device, system can be used to recognize sounds that occur outside of a structure that could not be wired to a conventional security system, and the system is less expensive to install as compared with existing systems. Another advantage of the system is that devices not normally monitored now can be. For example, a smoke or carbon monoxide detector that cannot be connected to a conventional security system can be monitored by the described system.

One embodiment of the security system uses a cellular transmitter to signal a monitoring station. This prevents an intruder from disabling the system by tampering with a land phone line or from the system being disabled in a fire destroying the land phone line.

One embodiment of the security system uses a sound recognition; to determine if an alarm has been activated. This allows the system to be installed where an existing system exists without having to trace the existing wires back to each alarm and connecting them correctly to the corresponding alarms of the security system. The installation process is simple enough that anyone can install the unit themselves. Additionally, a structure that has no existing security wiring can use this security system without the need to run wiring to the alarms or decode their radio frequencies. This translates into a system that is less expensive to install.

The sound recognition allows the user to program the system to alert the user to any type of audible alarm. This could include a door bell or any other device that produces a consistent sound the user wishes to monitor. This allows the user to set the security system to recognize alarms produced in areas where a wire connection would not be available. This could include alarms such as chemical spill sirens or other public notification alarms.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for programming a security system comprising:
activating a first audible alarm to create a sound;
converting the sound of the first audible alarm to an electronic signal;
processing the electronic signal to create a first acoustic fingerprint; and
storing the first acoustic fingerprint in a readable format.

2. The method of claim 1 further comprising activating a second audible alarm and creating a second acoustic fingerprint and storing the second acoustic fingerprint in a readable format.

3. The method of claim 1 wherein the audible alarm is a first smoke alarm.

4. The method of claim 3 wherein the second audible alarm is a second smoke alarm with a different sound from the first audible alarm.

5. A method for signaling comprising:
activating an audible alarm;
creating a first acoustic fingerprint from the audible alarm;
matching a sound of the audible alarm to a stored second acoustic fingerprint;
transmitting a first signal with a first set of data, that corresponds to the stored second acoustic fingerprint, to a central processing unit;
matching the first set of data to a second set of data; and
the central processing unit transmitting a second signal with the second set of data.

6. The method of claim 5 further comprising the second set of data being received by a first phone.

7. The method of claim 5 wherein the audible alarm is part of a home security system.

8. The method of claim 6 further comprising the first phone sending a third signal with a third set of data to the central processing unit.

9. The method of claim 8 further comprising the central processing unit sending a fourth signal with a fourth set of data.

10. The method of claim 9 the method of claim wherein the fourth set of data is determined based on information contained in the first set of data and the third set of data.

11. The method of claim 9 further comprising the fourth set of data being received by a second phone.

12. The method of claim 9 further comprising the fourth set of data being received by an emergency service.

13. The method of claim 9 further comprising delaying the transmission of the first signal with the first set of data.

14. A security system comprising:
an audible alarm
a microphone within acoustic range of the audible alarm;
a storage circuit configured to store at least one acoustic fingerprint;
a processing circuit coupled to the storage circuit and configured to create a first acoustic fingerprint from a first signal from the microphone and save the first acoustic fingerprint on the storage circuit, the processing circuit further configured to create a second acoustic fingerprint from a second signal from the microphone and compare the first acoustic fingerprint to the second acoustic fingerprint, the processing circuit further configured to transmit a set of data if the first acoustic fingerprint matches the second acoustic fingerprint; and
a transmitter coupled to the processing circuit and configured to transmit the set of data.

15. The security system of claim 14 further comprising a battery configured to provide power to the microphone, the storage circuit, the processing circuit, and the transmitter.

16. The security system of claim 14 further comprising a speaker coupled to the processing circuit

17. The security system of claim 14 wherein the set of data is transmitted through a cellular service.

18. The security system of claim 14 further comprising a light that indicates when the first acoustic fingerprint has been stored on the storage circuit.

19. The security system of claim 14 wherein the processing circuit is further configured to send and receive a cellular text message.

20. The security system of claim 16 wherein the security system if configured to act as a two way radio.
